(19) United States
(12) Patent Application Publication
(10) Pub. No.: US 2004/0045823 A1
(43) Pub. Date: Mar. 11, 2004

(54) Noiseless gas concentration measurement apparatus

(75) Inventors: Tomoo Kawase, Aichi-ken (JP); Eiichi Kurokawa, Okazaki-shi (JP)

Correspondence Address: NIXON & VANDERHYE, PC, 1100 N GLEBE ROAD, 8TH FLOOR, ARLINGTON, VA, 22201-4714, US

(73) Assignee: Denso Corporation, Aichi-pref (JP)

(21) Appl. No.: 10/649,794

(22) Filed: Aug. 28, 2003

(30) Foreign Application Priority Data
Aug. 30, 2002 (JP) 2002-253791

(51) Int. Cl. G01N 27/26

(52) U.S. Cl. 204/424; 204/426

(57) ABSTRACT

A noiseless circuit structure of a gas concentration measuring apparatus is provided. The gas concentration measuring apparatus includes a gas sensor which has a solid electrolyte body. The solid electrolyte body has two electrodes affixed thereto and forms a pump cell which is actuated by application of voltage to the electrodes. The voltage has one of discrete levels contributing to addition of undesirable spiky peaks to a pump cell current produced by the pump cell. The apparatus works to smooth or blur the voltage to be applied to the pump cell or the pump cell current, thereby eliminating the spiky peaks of the pump cell current.

### BACKGROUND OF THE INVENTION

1. Technical Field of the Invention

The present invention relates generally to a noiseless circuit structure of a gas concentration measuring apparatus equipped with a gas sensor.

2. Background Art

Typical gas sensors for use in automotive internal combustion engines uses an oxygen ion conductive solid electrolyte material such as zirconia. For instance, gas sensors are known which have formed therein a gas chamber and a cell which is made up of a pair of electrodes affixed to a solid electrolyte body to pump oxygen molecules (O₂) into or out of the gas chamber. Such a type of gas sensor works to transfer oxygen ions as carriers through the solid electrolyte body in response to application of voltage to the electrodes to pump the oxygen molecules into or out of the gas chamber. Gas sensors are known which include a plurality of cells of the above type in order to measure the concentration of NOx (nitrogen oxide), CO (carbon monoxide), and HC (hydro carbon).

Gas sensors of the above type usually include a first and a second gas chamber and a first and a second pump cell. The first pump cell works to pump oxygen molecules out of the first gas chamber to decrease the concentration of oxygen within the second gas chamber to a lower level. The second pump cell includes electrodes made up of metal active with NOx and works to reduce or oxidize gasses within the second gas chamber through a surface of one of the electrodes exposed to the second gas chamber to change the concentration of oxygen on the surface of the electrode. This causes an electric current to flow between the electrodes which is used to determine the concentration of NOx. Specifically, increased accuracy of determining the concentration of NOx is ensured by keeping the oxygen molecules remaining within the second gas chamber as small as possible and actuating the second pump cell quickly when the concentration of oxygen within the second gas chamber changes.

FIG. 17 illustrates a map listing relations between voltage applied to the pump cell and resultant current flowing through the pump cell. The map shows that increasing the voltage applied to the pump cell (which will also be referred to as a pump cell-applying voltage below) results in increased ability of the pump cell to pump the oxygen molecules, thereby increasing the current flowing between the electrodes of the pump cell (which will also referred to as a pump cell current below). The pump cell current is saturated at a value (i.e., a limiting current) indicative of the concentration of oxygen outside the gas chamber, that is, the concentration of oxygen contained in the gasses entering the gas chamber. When the concentration of oxygen outside the gas chamber increases, it will require increasing of the pumping ability of the pump cell, so that a lower limit of the pump cell-applying voltage needed to produce the limiting current. To this end, a target value of the pump cell-applying voltage is determined by look-up using the map of FIG. 17 as a function of the pump cell current indicating a pumped amount of oxygen to output a command voltage to adjust the pump cell-applying voltage.

The pump cell current-to-pump cell-applying voltage relation usually varies, as shown in FIG. 18, between pump cells due to an individual difference therebetween arising from the production tolerance. It is, thus, required to optimize the map, as illustrated in FIG. 17, for each gas sensor to absorb the individual difference.

Nowadays, microcomputers are expected to be suitable for optimizing the map. Fine adjustment of the map is achieved only by rewriting data in a ROM of the microcomputer. This is also useful for saving costs.

The use of the microcomputer to adjust the pump cell-applying voltage poses the following problem. The microcomputer works to output a feeding signal specifying the pump cell-applying voltage from an A/D converter. The feeding signal usually has one of discrete values. This may, as shown in FIG. 19, result in stepwise changes in the pump cell-applying voltage, thereby causing the pump cell current to have spiky peaks (i.e., a current change ΔI) as a function of susceptance of the pump cell. The spiky peaks contribute to a reduction in accuracy of determining the concentration of oxygen (O₂) and may also result in a difficulty in determining the pump cell-applying voltage correctly. Further, gas sensors designed to measure the concentration of NOx or CO as a function of a deviation of the concentration of oxygen arising from reduction or oxidization of NOx or CO also have a problem of reduction in accuracy of determining the concentration of NOx or CO.

### SUMMARY OF THE INVENTION

It is therefore a principal object of the present invention to avoid the disadvantages of the prior art.

It is another object of the present invention to provide a noiseless circuit structure of a gas concentration measuring apparatus.

According to one aspect of the invention, there is provided a gas concentration measuring apparatus which may be employed in burning control of an automotive internal combustion engine. The gas concentration measuring apparatus comprises: (a) a gas sensor including a sensor base and a pump cell, the sensor base including a solid electrolyte body which defines within the sensor base a gas chamber into which gases are admitted through a given diffusion resistance, the pump cell being made up of a first and a second electrode affixed to the solid electrolyte body with the first electrode exposed to the gas chamber and responsive to application of electricity to the first and second electrodes to pump a given gas component out of and into the gas chamber selectively to produce a sensor signal in the form of an electrical change as a function of a pumped amount of the oxygen; (b) an electricity control circuit working to produce a feeding signal having one of discrete electrical values to control the electricity applied to the first and second electrodes of the pump cell; (c) a sensor signal detecting circuit working to detect the sensor signal outputted form the pump cell and produce a sensor output as a function of concentration of the given gas component; and (d) a change limiting circuit working to limit a change in the sensor signal to within a given range, thereby removing noises from the sensor signal which arise from susceptance of the pump cell at the time of a switch between the discrete electrical values of the feeding signal.

In the preferred mode of the invention, the change limiting circuit is implemented by an integrating circuit which works to integrate the sensor signal.

The electricity control circuit works to determine a target value of the feeding signal as a function of the sensor signal.

A second pump cell is further provided which works to produce a pump signal as a function of concentration of the given gas component within a second gas chamber formed within the gas base downstream of the gas chamber. The electricity control circuit may alternatively work to determine the target value of the feeding signal as a function of the pump signal.

The electricity control circuit may alternatively be designed to produce a voltage modulated by a PWM signal and convert the modulated voltage into a DC voltage to be applied to the first and second electrodes of the pump cell.

The electricity control circuit works to produce the DC voltage within a range between binary voltage levels.

The electricity control circuit includes a modulating circuit working to switch the voltage between the binary voltage levels using the PWM signal.

According to the second aspect of the invention, there is provided a gas concentration measuring apparatus which comprises: (a) a gas sensor including a sensor base and a pump cell, the sensor base including a solid electrolyte body which defines within the sensor base a gas chamber into which gases are admitted through a given diffusion resistance, the pump cell being made up of a first and a second electrode affixed to the solid electrolyte body with the first electrode exposed to the gas chamber and responsive to application of electricity to the first and second electrodes to pump a given gas component out of and into the gas chamber selectively to produce a sensor signal in the form of an electrical change as a function of a pumped amount of the given gas component; (b) an electricity control circuit working to produce a feeding signal having one of discrete electrical values to control the electricity applied to the first and second electrodes of the pump cell; (c) a sensor signal detecting circuit working to detect the sensor signal outputted form the pump cell and produce a sensor output as a function of concentration of the given gas component; and (d) a blurring circuit working to blur a change in the sensor signal, thereby removing noises from the sensor signal which arise from susceptance of the pump cell at the time of a switch between the discrete electrical values of the feeding signal.

In the preferred mode of the invention, a change limiting circuit is further provided which works to limit the change in the sensor signal to within a given range prior to blur the change in the sensor signal.

The blurring circuit is implemented by an integrating circuit which works to integrate the sensor signal.

The electricity control circuit works to determine a target value of the feeding signal as a function of the sensor signal.

A second pump cell is further provided which works to produce a pump signal as a function of concentration of the given gas component within a second gas chamber formed within the gas base downstream of the gas chamber. The electricity control circuit may alternatively work to determine a target value of the feeding signal as a function of the pump signal.

The electricity control circuit may alternatively be designed to produce a voltage modulated by a PWM signal and convert the modulated voltage into a DC voltage to be applied to the first and second electrodes of the pump cell.

The electricity control circuit works to produce the DC voltage within a range between binary voltage levels.

The electricity control circuit includes a modulating circuit working to switch the voltage between the binary voltage levels using the PWM signal.

According to the third aspect of the invention, there is provided a gas concentration measuring apparatus which comprises: (a) a gas sensor including a sensor base and a pump cell, the sensor base including a solid electrolyte body which defines within the sensor base a gas chamber into which gases are admitted through a given diffusion resistance, the pump cell being made up of a first and a second-electrode affixed to the solid electrolyte body with the first electrode exposed to the gas chamber and responsive to application of electricity to the first and second electrodes to pump a given gas component out of and into the gas chamber selectively to produce a sensor signal in the form of an electrical change as a function of a pumped amount of the given gas component; (b) an electricity control circuit working to produce a feeding signal having one of discrete electrical values to control the electricity applied to the first and second electrodes of the pump cell; (c) a sensor signal detecting circuit working to detect the sensor signal outputted form the pump cell and produce a sensor output as a function of concentration of the given gas component; and (d) a blurring circuit working to blur the feeding signal produced by the electricity control circuit, thereby removing noises from the sensor signal which arise from susceptance of the pump cell at the time of a switch between the discrete electrical values of the feeding signal.

In the preferred mode of the invention, the blurring circuit is implemented by an integrating circuit which works to integrate the feeding signal.

The electricity control circuit works to determine a target value of the feeding signal as a function of the sensor signal.

A second pump cell may be provided which works to produce a pump signal as a function of concentration of the given gas component within a second gas chamber formed within the gas base downstream of the gas chamber. The electricity control circuit may alternatively work to determine a target value of the feeding signal as a function of the pump signal.

The electricity control circuit may alternatively be designed to produce a voltage modulated by a PWM signal and convert the modulated voltage into a DC voltage to be applied to the first and second electrodes of the pump cell.

The electricity control circuit works to produce the DC voltage within a range between binary voltage levels.

The electricity control circuit includes a modulating circuit working to switch the voltage between the binary voltage levels using the PWM signal.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a circuit block diagram which shows a gas concentration measuring apparatus according to the first embodiment of the invention;

FIG. 2 is a longitudinal sectional view which shows a gas sensor employed in the gas concentration measuring device of FIG. 1;

FIG. 3 is a sectional view taken along the line III-III in FIG. 2;

FIG. 4 is a sectional view taken along the line IV-IV in FIG. 2;

FIG. 5 is a flowchart of a program performed to determine voltage to be applied to a pump cell;

FIG. 6 shows changes in pump cell current indicating the concentration of oxygen (O₂);

FIG. 7 shows a change in voltage applied to a pump cell;

FIG. 8 shows a noise-caused change in pump cell current;

FIG. 9 is a circuit block diagram which shows a gas concentration measuring device according to the second embodiment of the invention;

FIG. 10 is a circuit block diagram which shows a gas concentration measuring device according to the third embodiment of the invention;

FIG. 11 is a circuit block diagram which shows a gas concentration measuring device according to the fourth embodiment of the invention;

FIG. 12 is a circuit block diagram which shows a gas concentration measuring device according to the fifth embodiment of the invention;

FIG. 13 is a circuit block diagram which shows a gas concentration measuring device according to the sixth embodiment of the invention;

FIG. 14 is a longitudinal sectional view which shows a gas sensor employed in the gas concentration measuring device of FIG. 13;

FIG. 15 is a circuit block diagram which shows a gas concentration measuring device according to the seventh embodiment of the invention;

FIG. 16 is a circuit block diagram which shows a gas concentration measuring device according to the eighth embodiment of the invention;

FIG. 17 shows a pump cell current-to-pump cell applying voltage map as employed in conventional gas concentration measuring devices;

FIG. 18 shows a variation in pump cell-applying voltage arising from a production tolerance of gas sensors; and

FIG. 19 shows a relation between a pump cell-applying voltage changing stepwise and a resultant change in pump cell current.

### DESCRIPTION OF THE PREFERRED EMBODIMENTS

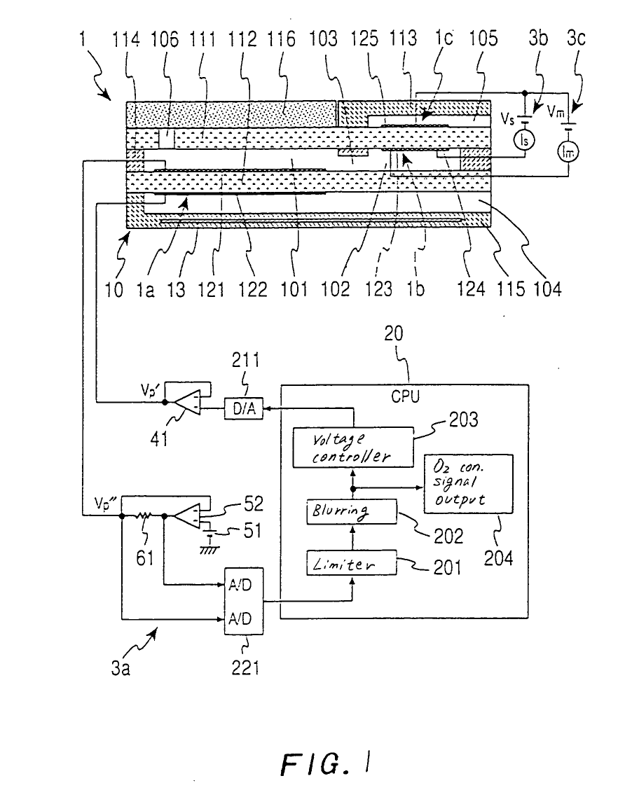

Referring now to the drawings, wherein like numbers refer to like parts in several views, particularly to FIG. 1, there is shown a gas concentration measuring device according to the first embodiment of the invention which consists essentially of a gas sensor 1 and a control circuit implemented by a CPU 20. The gas sensor 1 is installed, for example, in an exhaust pipe of an automotive internal combustion engine and exposed to exhaust gasses emitted from the engine. The control circuit is installed in a vehicle cabin or on a lower portion of a vehicle body and coupled with the gas sensor 1 through a wire cable. The control circuit is responsive to outputs from the gas sensor 1 to determine the concentration of nitrogen oxide (NOx), HC (hydro carbon), and CO (carbon monoxide) contained in exhaust gasses of the engine. In the following discussion, the gas sensor 1 is assumed to measure the concentration of NOx.

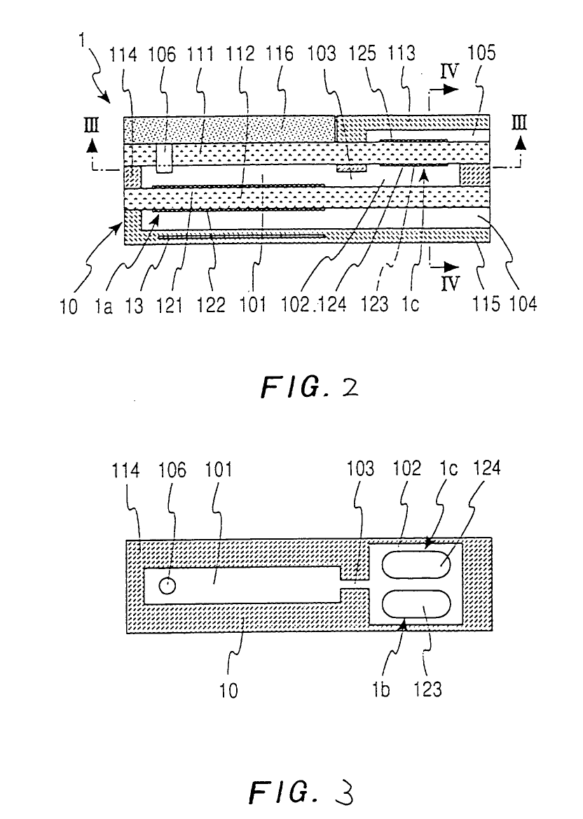

The gas sensor 1 is, as clearly shown in FIGS. 2 to 4, formed by a lamination of oxygen ion-conductive solid electrolyte layers 111 and 112 made of zirconia, insulating layers 113 and 114 made of alumina, and a layer 115 made of an insulating material such as alumina or a solid electrolyte material such as zirconia which are laid overlap each other in a thickness-wise direction of the gas sensor 1 in the form of a rectangular plate. The insulating layer 114 interposed between the solid electrolyte layers 111 and 112 has formed therein an opening to define two gas chambers 101 and 102, as will also be referred to as a first and a second chambers below, which communicate with each other through an orifice 103. The first and second chambers 101 and 102 are arrayed in a lengthwise direction of the gas senor 1. The second chamber 102 which is located closer to a base portion (i.e., atmospheric side) of the gas sensor 1 is two times wider than the first chamber 101 which is located closer to a head portion (i.e., gas-sensitive side) of the gas sensor 1.

Air ducts 104 and 105 are formed outside the solid electrolyte layers 111 and 112, respectively. The air ducts 104 and 105 communicate with the atmosphere at the side of the base portion of the gas sensor 1. The first air duct 104 extends over the first chamber 104 through the solid electrolyte layer 112. The second air duct 105 extends over the second chamber 102 through the solid electrolyte layer 111. The installation of the gas sensor 1 in an exhaust system of an automotive engine is achieved by inserting the gas sensor 1 partially into an exhaust pipe through a holder and communicating the air ducts 104 and 105 with the atmosphere. Specifically, the air ducts 104 and 105 are filled with air showing a reference oxygen concentration.

The solid electrolyte layer 111 has formed therein a pinhole 106 leading to the first chamber 101. A porous diffusion layer 116 is formed on the solid electrolyte layer 111 to avoid intrusion of exhaust fine particles into the firs chamber 101 and serves to provide limiting current characteristics. The pinhole 106 works to admit the gasses to be measured into the first chamber 101 which are flowing outside the porous diffusion layer 116.

The solid electrolyte layer 112 has formed on opposed surfaces thereof electrodes 121 and 122 exposed to the first chamber 101 and the air duct 104, respectively, and defines a pump cell 1a together with the electrodes 121 and 122. The electrode 121 exposed to the first chamber 101 is made of noble metal such as Au—Pt which is inactive with respect to NOx, that is, hardly decomposes NOx. The electrode 121 exposed to the first chamber 101 will also be referred to as a chamber-side pump electrode. The electrode 122 exposed to the air duct 104 will also be referred to as an air-side pump electrode.

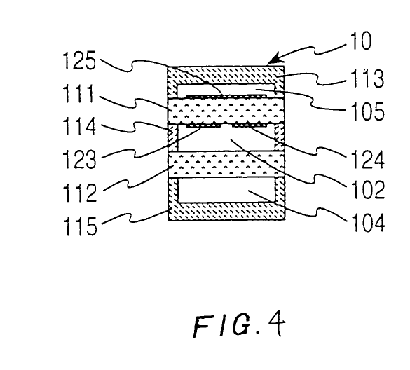

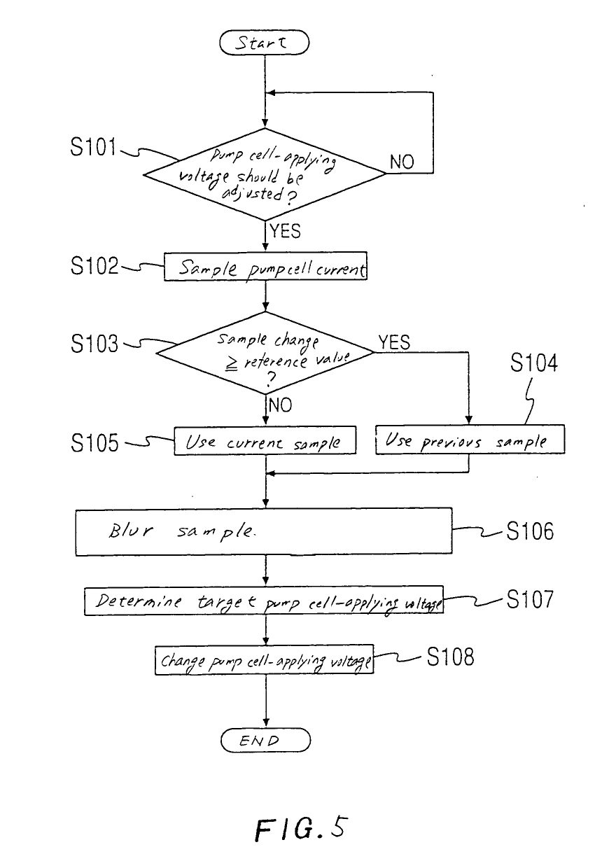

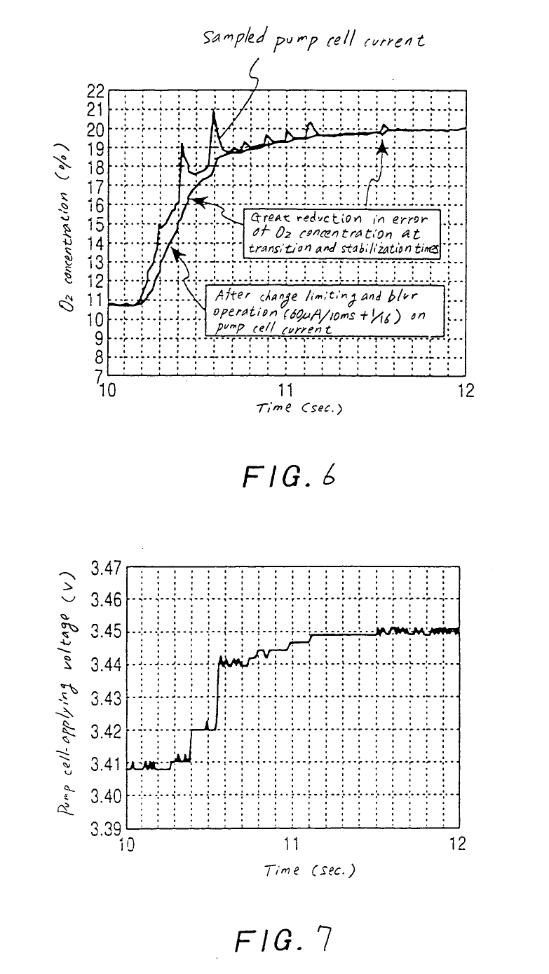

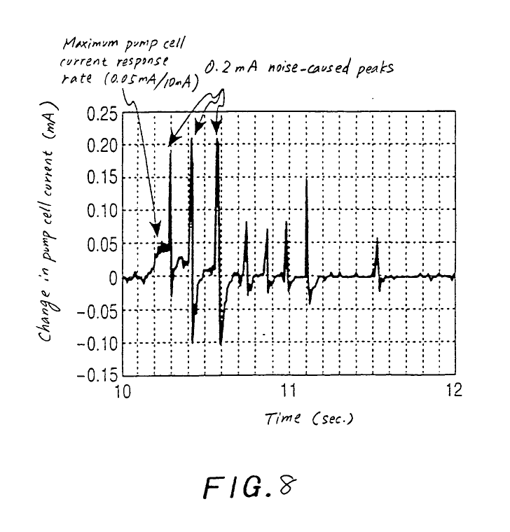

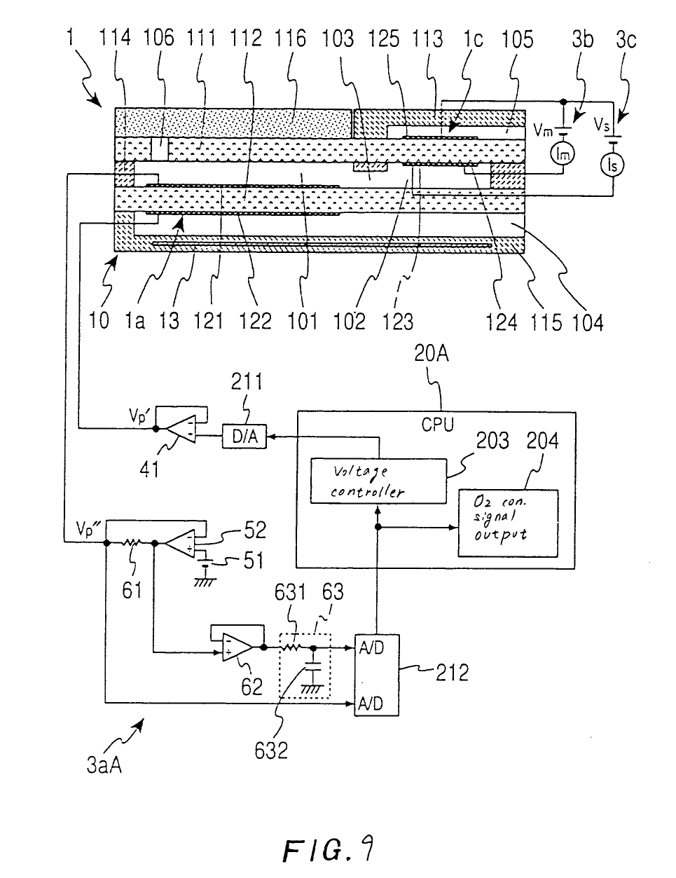

The solid electrolyte layer 111 has formed on opposed surfaces thereof electrodes 125, 123, and 124. The electrode 125 exposed to the air duct 105, as can be seen in FIG. 4, serves as an electrode common to the electrodes 123 and 124. The solid electrolyte layer 111 defines a monitor cell together with the electrodes 123 and 125 and a sensor cell 1c together with the electrode 124 and 125. The electrode 123 of the monitor cell 1b exposed to the second chamber 102 is made of noble metal such as Au—Pt which is inactive with respect to NOx, that is, hardly decomposes NOx. The electrode 124 of the sensor cell 1c exposed to the second chamber 102 is made of noble metal such as Pt which is active with respect to NOx, that is, serves to decompose or ionize NOx. The electrode 123 exposed to the second chamber 102 will also be referred to as a chamber-side monitor electrode. The electrode 124 exposed to the second chamber 102 will also be referred to as a chamber-side sensor electrode. The electrode 125 exposed to the air duct 105 will also be referred to as an air-side sensor/monitor electrode.

The layer 115 defining the air duct 104 together with the solid electrolyte layer 112 has embedded therein a Pt-made patterned conductor which works as a heater 13 for heating the whole of the gas sensor 1 (especially, the solid electrolyte layers 111 and 112) up to a desired activation temperature. The heater 13 is of an electrical type generating Joule heat.

The exhaust gasses of the engine flowing outside the gas sensor 1, as described above, enters the first chamber 101 through the porous diffusion layer 116 and the pinhole 106. Application of voltage to the pump cell 1a through the electrodes 121 and 122 with the electrode 122 connected to a positive terminal of a voltage source causes oxygen molecules contained in the exhaust gasses to undergo dissociation or ionization, so that the oxygen (O₂) is pumped out of the first chamber 101 to the air duct 104. If the concentration of the oxygen (O₂) is lower than a desired level in the first chamber 101, a reverse voltage is applied to the pump cell 1a to pump oxygen molecules into the first chamber 101 from the air duct 104 so as to keep the concentration of oxygen (O₂) within the first chamber 101 constant.

Increasing the voltage applied across the electrodes 121 and 122 of the pump cell 1a causes the majority of flow of oxygen (O₂) into the first chamber 101 from the pinhole 106 to depend on a diffusion resistance of the pinhole 106, so that a limiting current is produced in the pump cell 1a which is a function of the concentration of oxygen (O₂) contained in the exhaust gasses flowing outside the gas sensor 1. Since the chamber-side pump electrode 121, as described above, hardly decomposes NOx, NOx gas stays within the first chamber 101.

The exhaust gasses having entered the first chamber 101 diffuse into the second chamber 102. Specifically, the O₂ molecules in the exhaust gasses are usually not dissociated by the pump cell 1a completely, so that residual O₂ molecules flow into the second chamber 102 and reach the monitor cell 1b and the sensor cell 1c. The application of given voltage to the monitor cell 1b and the sensor cell 1c with the common electrode 125 coupled to the positive terminal of the voltage source causes the gasses within the second chamber 102 to be decomposed so that oxygen ions are discharged to the air duct 105, thereby producing limiting currents in the monitor cell 1b and the sensor cell 1c. Only the chamber-side sensor electrode 124 of the electrodes 123 and 124 exposed to the second chamber 102 is, as described above, active with NOx, so that the current flowing through the sensor cell 1c will be greater than that flowing through the monitor cell 1b by a value equivalent to the amount of oxygen ion arising from the dissociation or decomposition of NOx on the chamber-side sensor electrode 124 of the sensor cell 1c. Determination of the concentration of NOx contained in the exhaust gasses is, therefore, achieved by finding a difference between the currents flowing through the monitor cell 1b and the sensor cell 1c. EPO 987 546 A2, assigned to the same assignee as that of this application, teaches control of an operation of this type of gas sensor, disclosure of which is incorporated herein by reference.

Referring back to FIG. 1, the control circuit consists of the CPU 20, a pump cell circuit 3a, a monitor cell circuit 3b, and a sensor cell circuit 3c.

The pump cell circuit 3a consists of operational amplifiers 41 and 52, a D/A converter 211, an A/D converter 221, a resistor 61, and a reference voltage source 51. The D/A converter 211 receives a voltage command signal outputted from the CPU 20 and converts it into an analog voltage signal, which is, in turn, inputted as a feeding signal to the operational amplifier 41 serving as a voltage follower. The operational amplifier 41 works to apply the voltage Vp′ to the air-side pump electrode 122 of the pump cell 1a. The operational amplifier 52 which serves as a voltage follower receives an output voltage of the reference voltage source 51 and applies a reference voltage Vp″ to the chamber-side pump electrode 121 of the pump cell 1a. The resistor 61 is disposed in a line extending between the operational amplifier 52 and the chamber-side pump electrode 121. The resistor 61 works as a pumped oxygen amount detector. Specifically, the voltage is developed across the resistor 61 as a function of amount of oxygen pumped by the pump cell 1a and inputted to the A/D converter 221. When the voltage (i.e., Vp′-VP″), as will be referred to as a pump cell-applying voltage Vp below, is applied across the electrodes 121 and 122 of the pump cell 1a, it will cause the current Ip to flow between the electrodes 121 and 122, which is measured by the CPU 20 as a voltage drop across the resistor 61.

Each of the monitor cell circuit 3b and the sensor cell circuit 3c is similar in structure to the pump cell circuit 3a and includes operational amplifiers and a resistor. The monitor cell circuit 3b works to apply the voltage Vm across the electrodes 123 and 125 of the monitor cell 1b, as will be referred to as a monitor cell-applied voltage below, and measure the current flowing between the electrodes 123 and 125, as will be referred to as a monitor cell current Im below). Similarly, the sensor cell circuit 3c works to apply the voltage Vs across the electrodes 124 and 125 of the sensor cell 1c, as will be referred to as a sensor cell-applied voltage below, and measure the current flowing between the electrodes 124 and 125, as will be referred to as a sensor cell current Is below). The monitor cell circuit 3b is substantially identical in structure with the pump cell circuit 3a and works to control the monitor cell-applied voltage Vm through an output of a D/A converter.

The control circuit also works to determine the impedance of the pump cell 1a, the monitor cell 1b, or the sensor cell 1c. In practice, such a determination is achieved by measuring the impedance between the electrodes 123 and 125 of the monitor cell 1b which will be referred to as sensor impedance below. The determination of the sensor impedance is achieved by shifting an output voltage of the D/A converter of the monitor cell circuit 3b either to a positive side or a negative side instantaneously (e.g., for several tens or several hundreds of μsec.) to add an ac component to the monitor cell-applied voltage Vm and measuring a resultant change in the monitor cell current Im through the CPU 20. Specifically, the CPU 20 determines the sensor impedance based on the changes in the monitor cell-applied voltage Vm and the monitor cell current Im.

The heater 13 is supplied with power from a storage battery (not shown). Specifically, the CPU 20 outputs a pulse width modulated (PWM) signal to the heater 13 trough a heater driver (not shown) to control a supply of power to the heater 13. The CPU 20 determines the duty cycle of the PWM signal as a function of the sensor impedance. The sensor impedance has a value that is a function of the temperature of the solid electrolyte layers 111 and 112. The CPU 20 adjusts the duty cycle of the PWM signal so as to bring the sensor impedance into agreement with a preselected target one under feedback control, thereby keeping the temperature of the solid electrolyte layers 111 and 112 at a required activation temperature.

The operation of the gas concentration measuring apparatus of this embodiment will be described blow.

FIG. 5 shows a sequence of logical steps or program executed by the CPU 20 to control the pump cell-applying voltage Vp.

After entering the program, the routine proceeds to step 101 whether the time the pump cell-applying voltage Vp should be adjusted has been reached or not. The adjustment of the pump cell-applying voltage Vp is to be achieved at an interval of, for example, 10 ms. If a NO answer is obtained, then the routine repeats step 101. Alternatively, if a YES answer is obtained, then the routine proceeds to step 102 wherein the A/D converter 211 samples the voltage appearing across the resistor 61 to measure the pump cell current Im (which will also be referred to as an A/D-sampled value below).

Operations in steps 103 to 105 are to limit a change in output of the pump cell 1a within a given range. In the following steps, “X” generally indicates the A/D-measure value, “Xᵢ” indicates the A/D-sampled value in a current program cycle, and “Xᵢ₋₁” indicates the A/ D-sampled value one program cycle earlier.

In step 103, it is determined whether a change in A/D-sampled value X, that is, an absolute value of a difference between the values Xᵢ and Xᵢ₋₁ is greater than or equal to a preselected upper change limit ΔX or not.

If a YES answer is obtained (i.e., |Xᵢ−Xᵢ₋₁|≧ΔX), the routine proceeds to step 104 wherein one of values Xᵢ₋₁±ΔX is determined as having being derived in this program cycle. Specifically, if Xᵢ≧Xᵢ₋₁, meaning that the value Xᵢ in this program cycle has become greater than the value Xᵢ₋₁ in the previous program cycle over the upper change limit ΔX, the value Xᵢ₋₁+ΔX is determined to be the value Xᵢ as derived in this program cycle. Alternatively, if Xᵢ≦Xᵢ₋₁, meaning that the value Xᵢ in this program cycle has become smaller than the value Xᵢ₋₁ in the previous program cycle over the upper change limit ΔX, the value Xᵢ₋₁−ΔX is determined to be the value Xᵢ as derived in this program cycle. Specifically, if a change in the pump cell current Ip is greater than the upper change limit ΔX, the value X is corrected to be within a range of ±ΔX.

Alternatively, if a NO answer is obtained (i.e., |Xᵢ−Xᵢ₋₁|<ΔX), then the routine proceeds to step 105 wherein the A/D-sampled value Xᵢ as derived in this program cycle is used as it is.

After step 104 or 105, the routine proceeds to step 106 wherein a blur operation is performed.

Specifically, the A/D-sampled value Xᵢ is corrected by the following equation.

Xᵢ=Xᵢ₋₁+(Xᵢ−Xᵢ₋₁)/k

where k indicates a preselected blurring coefficient.

After step 106, the routine proceeds to step 107 wherein using the value Xᵢ derived in step 106 (i.e., a blurred value of the pump cell current Ip), a target value of the pump cell-applying voltage Vp is determined by looking up a pump cell current-to-applied voltage map.

The routine proceeds to step 108 wherein a feed control operation is performed to change the voltage Vp now being applied to the pump cell 1a to the target one as determined in step 107. Specifically, the output voltage Vp′ of the D/A converter 211 is changed to the target one.

In the CPU 20, as illustrated in FIG. 1, the above operations are represented by blocks. Specifically, the change limiting circuit 201 performs steps 103 to 105. The blurring circuit 202 performs step 106. The pump cell-applying voltage controller 203 performs step 107. The oxygen concentration signal output circuit 204 works to output the A/D-sampled value as blurred in step 106 as an A/F indicative of the concentration of oxygen (O₂) contained in the exhaust gasses.

With the above described sequential operations, the D/A converter 211 provides the output voltage Vp′ having one of discrete values, so that the pump cell-applying voltage Vp will have one of discrete values. Thus, if the pump cell current Ip, as sampled by the A/D converter 221, contains peaks, as shown in FIG. 19, they are eliminated by the change limiting circuit 201 and the blurring circuit 202 to produce the noiseless pump cell current Ip, thereby enabling the pump cell-applying voltage Vp to be determined correctly. This results in improved accuracy of determining the concentration of NOx.

The elimination of noise in the pump cell current Ip serves to prevent the pump cell-applying voltage Vp from being changed undesirably, thus resulting in stability of oxygen (O₂) remaining in the first and second chambers 101 and 102 which improves the accuracy of determining the concentration of NOx using the monitor cell 1b and the sensor cell 1c.

The beneficial effects offered by the first embodiment will also be described below with reference to FIGS. 6, 7, and 8.

FIG. 6 shows a time-sequential change in concentration of O₂ contained in exhaust gasses of a diesel engine during a fuel cut. An upper line represents the value of the pump cell current Ip (i.e., the A/D-sampled value) sampled and outputted by the A/D converter 221. A lower line represents the value of the pump cell current Ip after being blurred by the blurring circuit 202. Either value increases up to a normal atmospheric concentration of O₂ due to the fuel cut, but however, the value of the pump cell current Ip after being blurred by the blurring circuit 202 increases smoothly without any spiky noises.

FIG. 7 shows a time-sequential change in pump cell-applying voltage Vp as determined as a function of the pump cell current Ip. FIG. 8 shows a time-sequential change in pump cell current Ip immediately after being sampled at an interval of 10 ms by the A/D converter 221 (i.e., the A/D-sampled value). In the illustrated case, the pump cell current Ip increases at a maximum rate of 0.05 mA/10 ms due to the fuel cut. The concentration of O₂ changes most greatly during the fuel cut, therefore, a maximum value of a response rate of the pump cell current Ip may be determined as 0.05 mA/10 ms. The peak of the rate of change in the pump cell current Ip reaches about 0.2 mA/10 ms. This is because spiky noises are added to the pump cell current Ip which arise from the susceptance made up of the parasitic capacitance between the electrodes 121 and 122 of the pump cell 1a and the capacitance of the solid electrolyte layer 112 due to stepwise changes in the pump cell-applying voltage Vp.

If a change in the pump cell-applying voltage Vp is defined as ΔV1, and the impedance of the pump cell 1a is defined as ZAC, then the a change ΔI1 in the pump cell current Ip may be expressed by a relation of ΔI1=ΔV1/ZAC. A maximum value of the pump cell-applying voltage change ΔV1 depends upon a resolution of the D/A converter 211. When the D/A converter 211 is implemented by a 12-bit D/A converter that is now available, an LSB will be 1.22 mV. If the impedance ZAC of the pump cell 1a is 20 Ω, the pump cell-applying voltage change ΔV1 due to the fact that the output voltage of the D/A converter 211 has a discrete value is calculated approximately as 60 μA. This will result in a great error equivalent to an A/F (air/fuel) ratio of one (1) corresponding to 1% concentration of O₂, for example, when the A/F ratio is twenty three (23) which is usually employed in lean burn or direct injection gasoline engines or great EGR control of diesel engines.

A reduction in such error without sacrificing the rate of response of the pump cell current Ip to a change in concentration of O₂ in the engine is, therefore, achieved by setting a limit of the pump cell current change ΔI1 to 60 μA. The lower line, as illustrated in FIG. 6, indicates the data when the upper change limit ΔX, as used in the change limiting operation in steps 103 to 105, is 60 μA.

A further reduction in noise added to the pump cell current Ip is achieved by blurring the A/D-sampled value in steps 106. The blurring coefficient k is preferably determined in terms of a required effect of removing the spiky noises from the pump cell current Ip and the response rate of the pump cell current Ip. The inventors of this application have found experimentally that ⅛ to 1/16 are suitable for the blurring coefficient k. The lower line indicates the data when the blurring coefficient k is 1/16.

The change limiting operation in steps 103 to 105 and the blurring operation in steps 106 are not necessarily performed together, but a desired reduction in noise added to the pump cell current Ip may be achieved by at least one of them.

FIG. 9 shows a gas concentration measuring device according to the second embodiment of the invention. The same reference numbers as employed in the first embodiment will refer to the same parts, and explanation thereof in detail will be omitted here.

The gas concentration measuring device includes a pump cell circuit 3aA and a CPU 20A. The pump cell circuit 3aA includes an operational amplifier 62 serving as a voltage follower and a low-pass filter 63. The voltage appearing at a junction of the resistor 61 and the operational amplifier 52 is inputted to the operational amplifier 62. An output of the operational amplifier 62 is inputted to the A/D converter 212 through the low-pass filter 63. The low-pass filter 63 is implemented by an integrating circuit made up of a resistor 631 and a capacitor 632. The pump cell current Ip sampled by the A/D converter 212 is inputted to the CPU 20A.

The CPU 20A includes the pump cell-applying voltage controller 203 and the oxygen concentration signal output circuit 204. The pump cell-applying voltage controller 203 is responsive to input of the pump cell current Ip (i.e., the A/D-sampled value) to control the pump cell-applying voltage Vp.

The low-pass filter 63 works to smooth or blur the output of the operational amplifier 62 (i.e., the pump cell current Ip), thereby eliminating, like the first embodiment, spiky peaks appearing at the pump cell current Ip during a transition period in which the pump cell-applying voltage Vp is changed stepwise. The structure of this embodiment is lower in control load than that of the first embodiment.

The gas concentration measuring device of this embodiment, unlike the first embodiment, does not work to remove the spiky peaks from the pump cell current Ip before being subjected to the blurring operation. Sufficient removal of the spiky peaks from the pump cell current Ip, thus, requires decreasing the cut-off frequency of the low-pass filter 63 (e.g., to 0.5 Hz). The structure of this embodiment is useful for applications in which a certain degree of response delay is allowed.

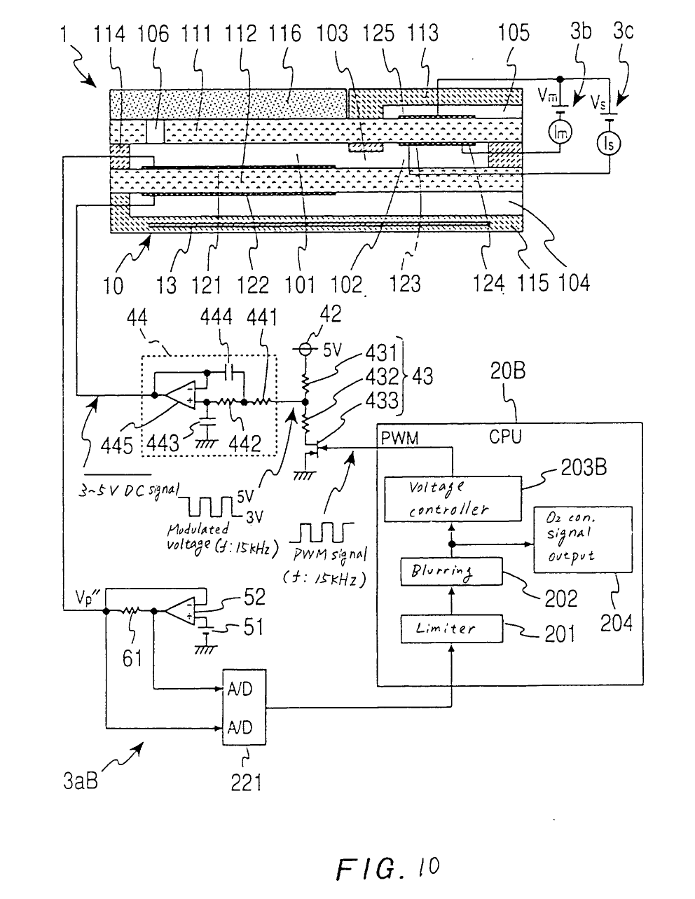

FIG. 10 shows a gas concentration measuring device according to the third embodiment of the invention. The same reference numbers as employed-in the above embodiments will refer to the same parts, and explanation thereof in detail will be omitted here.

The adjustment of the pump cell-applying voltage Vp is achieved by changing an output of the D/A converter 211 in the first embodiment, but it is accomplished using another means in this embodiment.

The CPU 20B includes a pump cell-applying voltage controller 203B which works to determines a duty cycle of a PWM signal as a function of the pump cell-applying voltage Vp as derived using an applying voltage map and output it.

The PWM signal is inputted to a gate of an FET 433 of the pump cell circuit 3aB. The FET 433 makes up a modulating circuit 43 together with resistors 431 and 432 which is designed to modulate an output of a voltage source 42 in response to the PWM signal. The voltage source 42 works to output a constant voltage. The modulating circuit 43 provides a power supply signal to the air-side pump electrode 122 through a low-pass filter 44. The resistors 431 and 432 and the FET 433 are connected in series between the voltage source 42 and ground. The voltage source 42 supplies the voltage to the low-pass filter 44 through the resistor 431. The low-pass filter 44 is implemented by an integrating circuit made up of resistors 441 and 442, capacitors 443 and 444, and an operational amplifier 445.

In operation, when the PWM signal inputted to the gate of the FET 433 has a logical one (1) to turn on the FET 433, it will cause the resistance at an input side of the low-pass filter 44 to be decreased by an amount equivalent to the resistance of the resistor 432 disposed electrically between the input of the low-pass filter 44 and ground. Specifically, the voltage inputted to the low-pass filter 44 has a binary discrete value which is either a logical one (1) or zero (0) depending upon if the PWM signal has the logical one (1) or zero (0). A ratio of a high-level time for which the discrete value has the logical one (1) to a low-level time for which the discrete value has the logical zero (0) is set by the duty cycle of the PWM signal. In this way, the output voltage of the voltage source 42 is modulated by the PWM signal outputted by the CPU 20B.

The voltage output of the modulating circuit 43 is smoothed or blurred by the low-pass filter 44 and applied to the air-side pump electrode 122 of the pump cell 1a. The applied voltage, thus, has substantially a constant value in the form of a DC signal within a range between the logical one (1) and zero (0) which is determined by the duty cycle of the PWM signal. Specifically, the longer the on time of the duty cycle of the PWM signal, the lower the level of the voltage applied to the air-side pump electrode 122.

The range of the level of the voltage inputted to the low-pass filter 44 is between a high and a lower level determined by the resistance values of the resistors 431 and 432. Thus, increase in resolution of the pump cell-applying voltage Vp is achieved by selecting the resistance values of the resistors 431 and 432 appropriately. The inventors of this application have found experimentally that the cut-off frequency of the low-pass filter 44 is preferably 107 Hz.

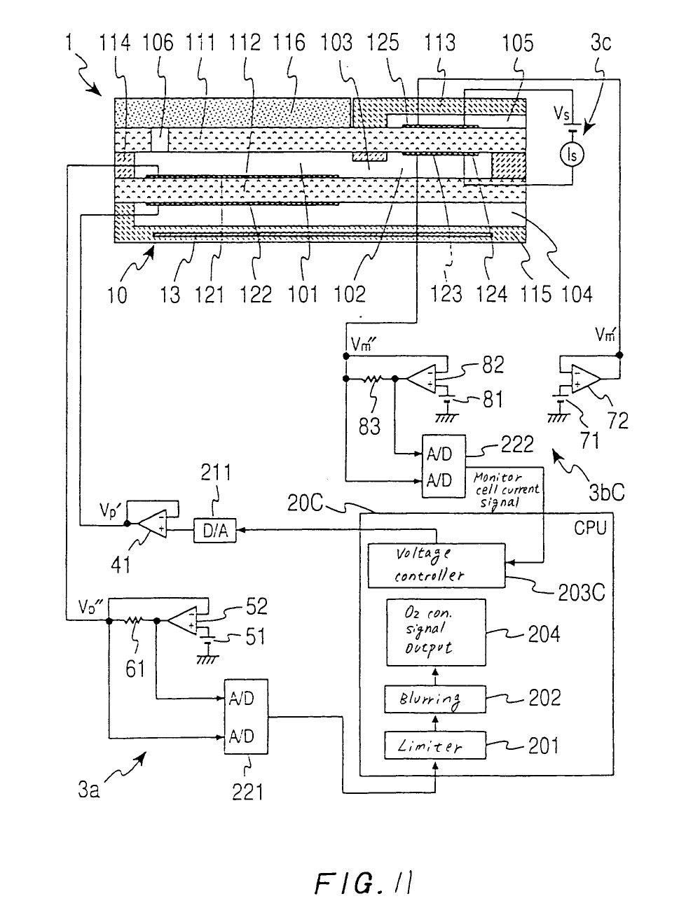

FIG. 11 shows a gas concentration measuring device according to the fourth embodiment of the invention which is different from the first embodiment in control of the pump cell-applying voltage Vp. The same reference numbers as employed in the above embodiments will refer to the same parts, and explanation thereof in detail will be omitted here.

The CPU 20C includes a pump cell-applying voltage controller 203C. The monitor cell circuit 3bC includes operational amplifiers 72 and 82, and an A/D converter 222. An output of a reference voltage supply 71 is inputted to the operational amplifier 72. The operational amplifier 72 applies a reference voltage Vm′ to the air-side sensor/monitor electrode 125 of the monitor cell 1b. Similarly, an output of a reference voltage supply 81 is inputted to the operational amplifier 82. The operational amplifier 82 applies a reference voltage Vm″ to the chamber-side monitor electrode 123 of the monitor cell 1b. Specifically, when a monitor cell-applying voltage Vm is inputted across the electrodes 123 and 125, it will cause the monitor cell current Im to flow between the electrodes 123 and 125, which is detected as a voltage drop of the resistor 83 by the A/D converter 222.

The pump cell-applying voltage controller 203C of the CPU 20C works to determine the pump cell-applying voltage Vp so as to bring the monitor cell current Im into agreement with a preselected one under feedback control. For instance, a PID control using the proportional and the integral is performed to determine the pump cell-applying voltage Vp and control the output voltage Vp′ of the D/A converter 211. The pump cell-applying voltage controller 203C is implemented logically by the CPU 20.

The output voltage Vp′ of the D/A converter 211 has, like the above embodiments, a discrete value, thus causing the pump cell current Ip to have spiky peaks, which results in a decrease in accuracy of determining the concentration of oxygen (O₂). The elimination of the spiky peaks of the pump cell current Ip is, like the first embodiment, achieved by subjecting samples of the pump cell current Ip collected by the A/D converter 221 to the change limiting operation and the blurring operation in the change limiting circuit 201 and the blurring circuit 202.

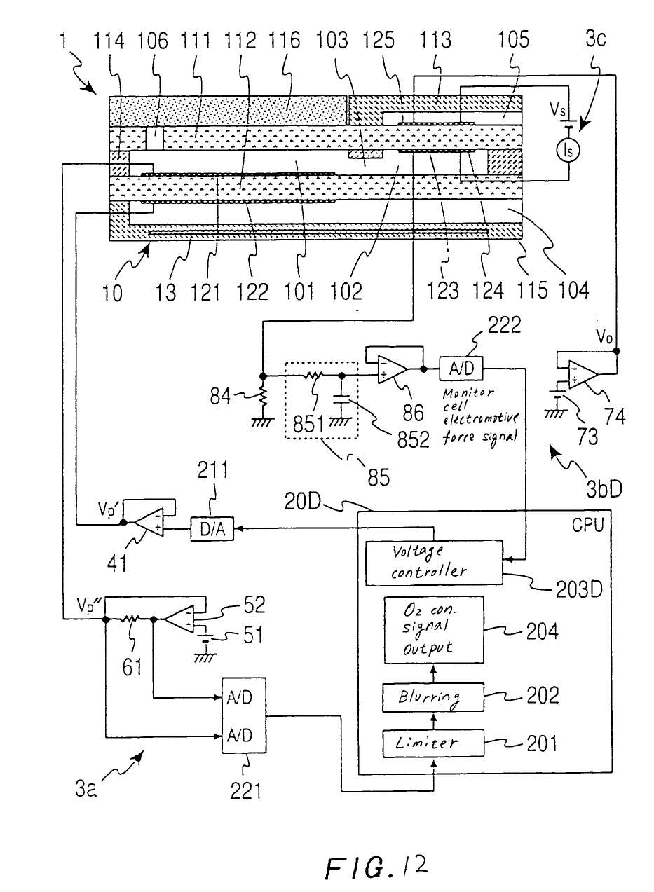

FIG. 12 shows a gas concentration measuring device according to the fifth embodiment of the invention which is different from the fourth embodiment in control of the pump cell-applying voltage Vp. The same reference numbers as employed in the above embodiments will refer to the same parts, and explanation thereof in detail will be omitted here.

The CPU 20D includes a pump cell-applying voltage controller 203D. The monitor cell circuit 3bD includes operational amplifiers 74 and 86, the A/D converter 222, a low-pass filer 85, and a resistor 84. An output of a reference voltage source 73 is inputted to the operational amplifier 74. The operational amplifier 74 applies a reference voltage Vo to the air-side sensor/monitor electrode 125 of the monitor cell 1b. The resistor 84 having a greater resistance value is joined to the chamber-side monitor electrode 123 of the monitor cell 1b. The voltage developed across the resistor 84 is inputted to the low-pass filter 85. The monitor cell 1b is designed to produce an electromotive force em between the electrodes 123 and 125 as a function of a ratio of a partial pressure of oxygen (O₂) within the chamber 102 to that within the air duct 105. A change in concentration of oxygen within the chamber 102 will result in a change in voltage inputted to the low-pass filter 85. The electromotive force em shows approximately 0.9V when the concentration of oxygen (O₂) within the chamber 102 is higher, drops greatly when it reaches a value corresponding to the stoichiometric amount of air, and has approximately 0.1V when it decreases to a rich-side.

The low-pass filter 85 consists of a resistor 851 and a capacitor 852. An output voltage of the low-pass filter 85 is inputted to the A/D converter 222 through the operational amplifier 86.

The pump cell-applying voltage controller 203D of the CPU 20D works to determine the pump cell-applying voltage Vp as a function of the electromotive force em. For instance, the electromotive force em produced by the monitor cell 1b changes, as described above, within a range between 0.9V and 0.1V across a middle voltage equivalent to the stoichiometric amount of air. The pump cell-applying voltage controller 203D, thus, determines the pump cell-applying voltage Vp so that the electromotive force em may reach 0.45V and controls an output of the D/A converter 211. The pump cell-applying voltage controller 203D is implemented logically within the CPU 20D.

The output voltage Vp′ of the D/A converter 211 has, like the above embodiments, a discrete value, thus causing the pump cell current Ip to have spiky peaks, which results in a decrease in accuracy of determining the concentration of oxygen (O₂). The elimination of the spiky peaks of the pump cell current Ip is, like the first embodiment, achieved by subjecting samples of the pump cell current Ip collected by the A/D converter 221 to the change limiting operation and the blurring operation in the change limiting circuit 201 and the blurring circuit 202.

The low-pass filter 85 serves to smooth a sudden change in electromotive force em to avoid an undesirable change in the pump cell-applying voltage Vp, thus resulting in improved convergence of the concentration of oxygen within the chamber 102.

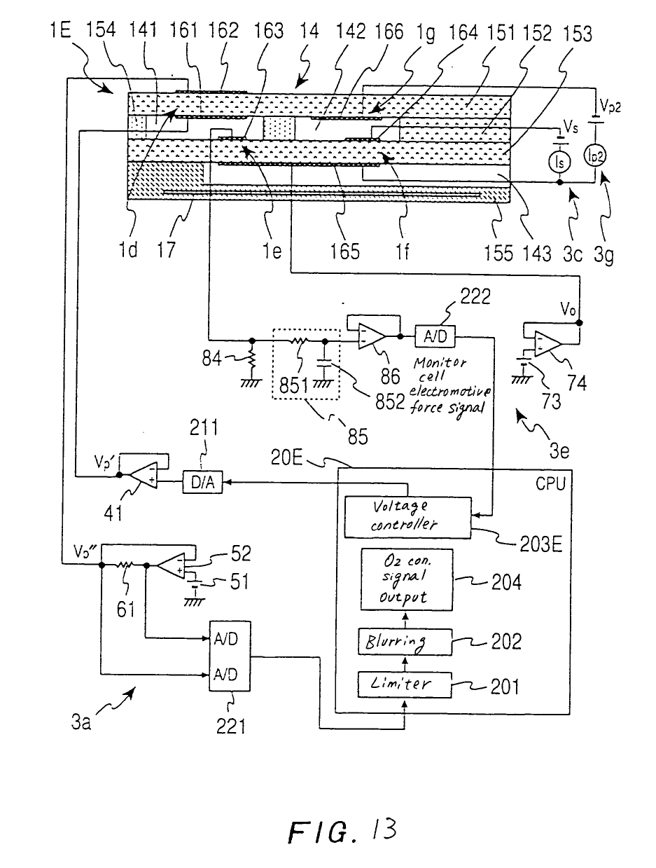

FIG. 13 shows a gas concentration measuring device according to the sixth embodiment of the invention which is different from the fifth embodiment in structure of the gas sensor. The control of the pump cell-applying voltage Vp is identical with that in the fifth embodiment. The same reference numbers as employed in the fifth embodiment will refer to the same parts, and explanation thereof in detail will be omitted here.

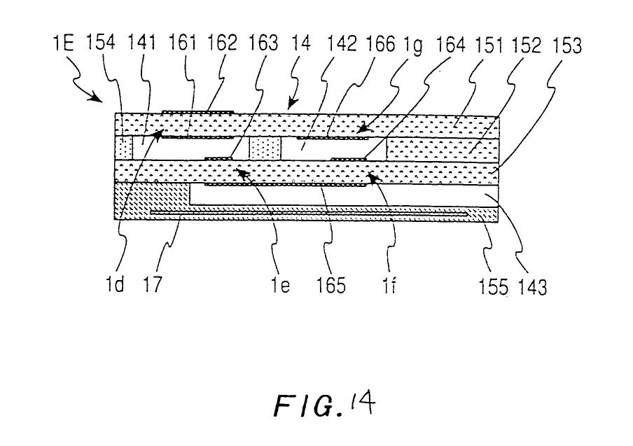

The gas sensor 1E, as clearly shown in FIG. 14, is formed by a strip-like lamination of solid electrolyte layers 151, 152, and 153 made of zirconia, a gas-diffusion-rate limiting layer 154 made of insulating material such as porous alumina, and a solid electrolyte layer 155 made of zirconia having a heater 17 embedded therein.

The solid electrolyte layer 152 and the gas-diffusion-rate limiting layer 154 form a common layer interposed between the solid electrolyte layers 151 and 153. The gas-diffusion-rate limiting layer 154 is located closer to the head portion of the gas sensor, while the solid electrolyte layer 152 is located closer to the base portion of the gas sensor. The solid electrolyte layer 152 and the gas-diffusion-rate limiting layer 154 have formed therein openings to define first and second chambers 141 and 142 arrayed in a lengthwise direction of the gas sensor. The gas-diffusion-rate limiting layer 154 works to admit gasses to be measured into the first chamber 141 and establish gas communication between the first and second chambers 141 and 142.

The layer 155 defines an air duct 143 between itself and the solid electrolyte layer 153. The air duct 143 extends over the first and second chambers 141 and 142 and communicates with the atmosphere. In a case where the gas sensor 1E is installed in an exhaust pipe of an automotive internal combustion engine, the air duct 143 is exposed outside the exhaust pipe.

Electrodes 161 and 162 are affixed to opposed surfaces of the solid electrolyte layer 151 to, form a pump cell 1d. The electrode 161 exposed to the chamber 141 is made of a noble metal such as Au—Pt that is inactive with NOx, that is, hardly decomposes NOx.

Electrode 163 and 165 are affixed to opposed surfaces of the solid electrolyte layer 153 to form a monitor cell 1e. The electrode 163 is exposed to the first chamber 141. The electrode 165 is exposed to the air duct 143. The electrode 163 exposed to the first chamber 141 is made of a noble metal such as Au—Pt that is inactive with NOx. The electrode 165 extends up to the second chamber 142 and works as a common electrode shared with a sensor cell if and a second pump cell 1g, as will be described below.

An electrode 164 is affixed to a surface of the solid electrolyte layer 153 exposed to the second chamber 142. The electrode 164 forms the sensor cell 1f together with the common electrode 165.

An electrode 166 is affixed to a surface of the solid electrolyte layer 151 exposed to the second chamber 142 to form the second pump cell 1g together with the solid electrolyte layers 151 to 153 and the electrode 165.

The electrode 164 of the sensor cell if exposed to the second chamber 142 is made of a noble metal such as Pt that is active with NOx, that is, works to decompose or ionize NOx. The electrode 166 of the second pump cell 1g is made of a noble metal such as Au—Pt that is inactive with NOx.

A patterned conductor is embedded in the layer 155 which makes up the heater 17 to heat the whole of the gas sensor 1E up to a required activation temperature. The heater 17 is of an electrical type generating Joule heat.

The monitor cell 1e produces an electromotive force em as a function of the concentration of O₂ within the first chamber 141. The monitor cell circuit 3e, like the fifth embodiment, consists of the reference voltage source 73, the operational amplifier 74, the resistor 84, the low-pass filter 85, and the operational amplifier 86 and works to measure the concentration of oxygen (O₂) remaining within the first chamber 141.

The pump cell-applying voltage controller 203E of the CPU 20E works to determine the pump cell-applying voltage Vp so that the electromotive force em produced by the monitor cell 1b may reach a given voltage (e.g., 0.45V) and controls an output of the D/A converter 211, thereby discharging the oxygen (O₂) from the first chamber 141 so that the concentration of O₂ is kept at a constant lower level. This also discharges O₂ from the second chamber 142 to keep the concentration of O₂ within the second chamber 142 at substantially the same lower level as in the first chamber 141.

The second pump cell circuit 3g works to apply the voltage Vp2 across the electrodes 165 and 166 with the electrode 165 connected to a positive terminal of a power supply to discharge O₂ from the second chamber 142. Upon application of the voltage Vp2, the electrodes 165 and 166 produce the pump cell current Ip2.

The sensor cell circuit 3c works to apply the voltage Vs across the electrodes 165 and 164 with the electrode 165 connected to a positive terminal of a power supply to discharge O₂ from the second chamber 142. Upon application of the voltage Vs, the electrodes 165 and 164 produce the sensor cell current Is as a function of concentration of NOx within the second chamber 142.

The above operations are known in the art, and explanation thereof in more detail will be omitted here.

The output voltage Vp′ of the D/A converter 211 has, like the above embodiments, a discrete value, thus causing the pump cell current Ip to have spiky peaks, which results in a decrease in accuracy of determining the concentration of oxygen (O₂). The elimination of the spiky peaks of the pump cell current Ip is, like the first embodiment, achieved by subjecting samples of the pump cell current Ip collected by the A/D converter 221 to the change limiting operation and the blurring operation in the change limiting circuit 201 and the blurring circuit 202.

The low-pass filter 85 serves to smooth a sudden change in electromotive force em to avoid an undesirable change in the pump cell-applying voltage Vp, thus resulting in improved convergence of the concentration of oxygen within the chamber 102.

FIG. 15 shows a gas concentration measuring device according to the seventh embodiment of the invention which is different from the second embodiment of FIG. 9 in that a low-pass filter 45 is used instead of the low-pass filter 63 in FIG. 9. The same reference numbers as employed in the second embodiment will refer to the same parts, and explanation thereof in detail will be omitted here.

The gas concentration measuring device includes a pump cell circuit 3aF and a CPU 20F. The pump cell circuit 3aF has the low-pass filter 45 to which an output voltage of the D/A converter 211 is inputted. The low-pass filter 45 is implemented by an integrating circuit made up of a resistor 451 and a capacitor 452 and works to output the pump cell-applying voltage Vp′ to the air-side pump electrode 122 of the pump cell 1a.

The CPU 20F includes the pump cell-applying voltage controller 203 and the oxygen concentration signal output circuit 204. The pump cell-applying voltage controller 203 is responsive to input of the pump cell current Ip (i.e., the A/D-sampled value) to control the pump cell-applying voltage Vp.

The low-pass filter 45 works to smooth or blur the output of the operational amplifier 41 (i.e., the pump cell-applying voltage Vp′), thereby eliminating, like the first embodiment, spiky peaks appearing at the pump cell current Ip during a transition period in which the pump cell-applying voltage Vp′ is changed stepwise. The structure of this embodiment is lower in control load than that of the first embodiment.

Removal of as much of the spiky peaks of the pump cell current Ip as possible requires decreasing the cut-off frequency of the low-pass filter 45. The inventors of this application have found experimentally that when the cut-off frequency is 0.5 Hz, and a minimum resolution of the D/A converter 211 is 2 mV, a change in pump cell current Ip arising from a 2 mV change in pump cell-applying voltage Vp′ is reduced from 0.1 mA (corresponding to an A/F ratio of 1.2) to 0.005 mA (corresponding to an A/F ratio of 0,06).

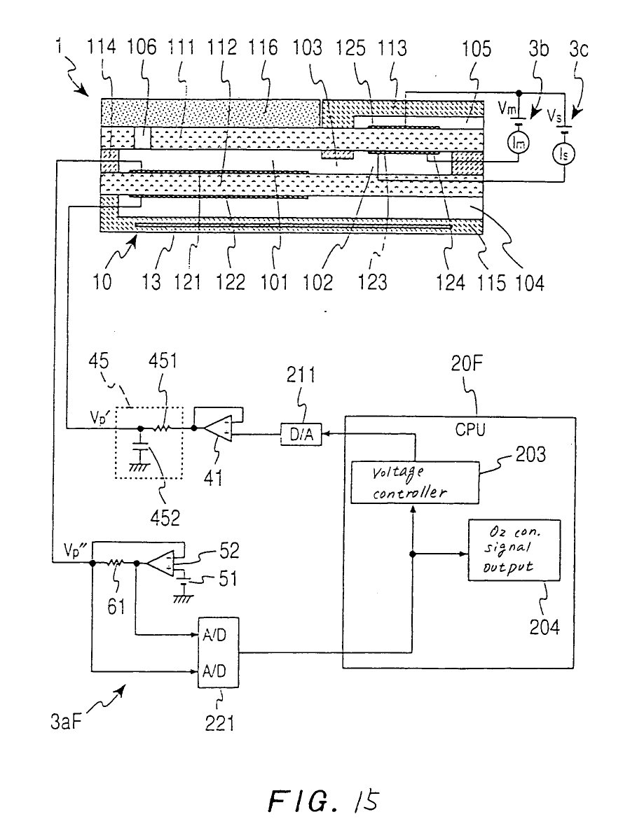

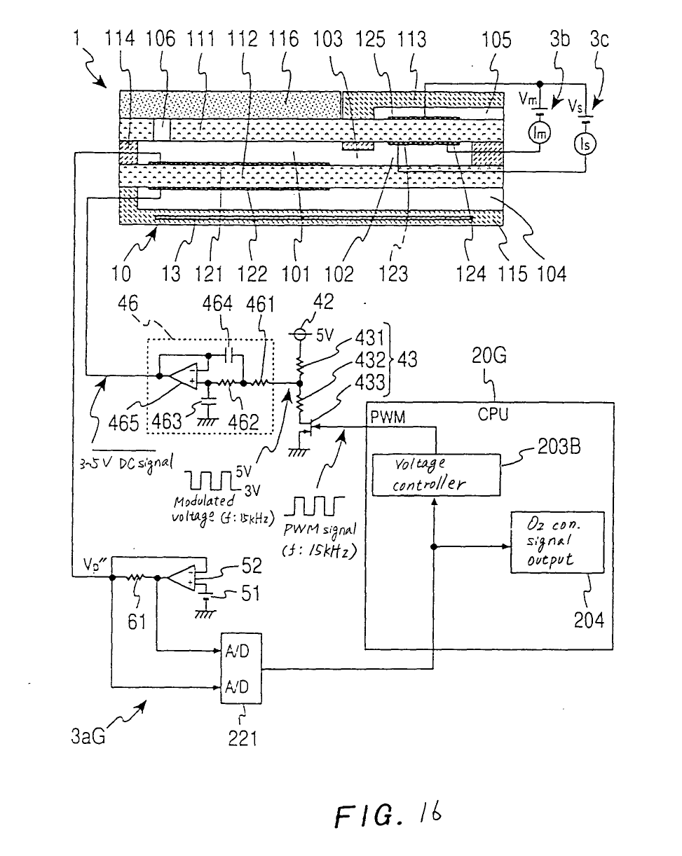

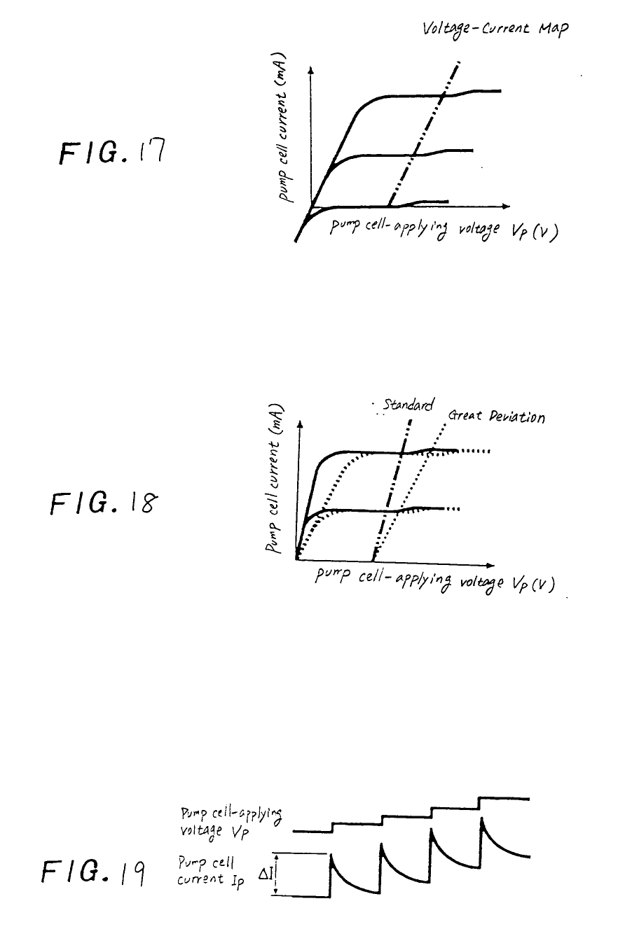

FIG. 16 shows a gas concentration measuring device according to the eighth embodiment of the invention which is a modification of the third embodiment of FIG. 10. The same reference numbers as employed in the third embodiment will refer to the same parts, and explanation thereof in detail will be omitted here.

The gas concentration measuring device includes a low-pass filter 46 working to smooth or blur an output of the modulating circuit 43. The low-pass filter 46, like the low-pass filter 44 of FIG. 10, consists of resistors 461 and 462, capacitors 463 and 464, and an operational amplifier 465. The low-pass filter 46 has a cut-off frequency lower than that of the low-pass filter 44, thereby providing additional effects of limiting a change in the pump cell-applying voltage Vp to within a desired range and smoothing the pump cell-applying voltage Vp in addition to smoothing an output of the voltage source 42 that is modulated by the PWM signal outputted by the CPU 20G. This eliminates the need for the blurring circuit 202 and the change limiting circuit 201 as employed in the structure of FIG. 10, thus resulting in a decrease in operation load of the CPU 20G.

The pump cell-applying voltage controller 203B works to determine the pump cell-applying voltage Vp as a function of the pump cell current Ip sampled by the A/D converter 221.

Smoothing the pump cell-applying voltage Vp to a degree which eliminates the spiky peaks of the pump cell current Ip requires decreasing the cut-off frequency of the low-pass filter 46 greatly. The inventors of this application have found experimentally that the cut-off frequency of the low-pass filter 46 is preferably 0.5 Hz.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas concentration measuring apparatus comprising:
a gas sensor including a sensor base and a pump cell, the sensor base including a solid electrolyte body which defines within the sensor base a gas chamber into which gases are admitted through a given diffusion resistance, the pump cell being made up of a first and a second electrode affixed to the solid electrolyte body with the first electrode exposed to the gas chamber and responsive to application of electricity to the first and second electrodes to pump a given gas component out of and into the gas chamber selectively to produce a sensor signal in the form of an electrical change as a function of a pumped amount of the given gas component;
an electricity control circuit working to produce a feeding signal having one of discrete electrical values to control the electricity applied to the first and second electrodes of the pump cell;
a sensor signal detecting circuit working to detect the sensor signal outputted form the pump cell and produce a sensor output as a function of concentration of the given gas component; and
a change limiting circuit working to limit a change in the sensor signal to within a given range.

2. A gas concentration measuring apparatus as set forth in claim 1, wherein said change limiting circuit is implemented by an integrating circuit which works to integrate the sensor signal.

3. A gas concentration measuring apparatus as set forth in claim 1, wherein said electricity control circuit works to determine a target value of the feeding signal as a function of the sensor signal.

4. A gas concentration measuring apparatus as set forth in claim 1, further comprising a second pump cell working to produce a pump signal as a function of concentration of the given gas component within a second gas chamber formed within said gas base downstream of the gas chamber, and wherein said electricity control circuit works to determine a target value of the feeding signal as a function of the pump signal.

5. A gas concentration measuring apparatus as set forth in claim 1, wherein said electricity control circuit is designed to produce a voltage modulated by a PWM signal and convert the modulated voltage into a DC voltage to be applied to the first and second electrodes of the pump cell.

6. A gas concentration measuring apparatus as set forth in claim 5, wherein said electricity control circuit works to produce the DC voltage within a range between binary voltage levels.

7. A gas concentration measuring apparatus as set forth in claim 6, wherein said electricity control circuit includes a modulating circuit working to switch the voltage between the binary voltage levels using the PWM signal.

8. A gas concentration measuring apparatus comprising:
a gas sensor including a -sensor base and a pump cell, the sensor base including a solid electrolyte body which defines within the sensor base a gas chamber into which gases are admitted through a given diffusion resistance, the pump cell being made up of a first and a second electrode affixed to the solid electrolyte body with the first electrode exposed to the gas chamber and responsive to application of electricity to the first and second electrodes to pump a given gas component out of and into the gas chamber selectively to produce a sensor signal in the form of an electrical change as a function of a pumped amount of the given gas component;
an electricity control circuit working to produce a feeding signal having one of discrete electrical values to control the electricity applied to the first and second electrodes of the pump cell;
a sensor signal detecting circuit working to detect the sensor signal outputted form the pump cell and produce a sensor output as a function of concentration of the given gas component; and
a blurring circuit working to blur a change in the sensor signal.

9. A gas concentration measuring apparatus as set forth in claim 8, further comprising a change limiting circuit working to limit the change in the sensor signal to within a given range prior to blur the change in the sensor signal.

10. A gas concentration measuring apparatus as set forth in claim 8, wherein said blurring circuit is implemented by an integrating circuit which works to integrate the sensor signal.

11. A gas concentration measuring apparatus as set forth in claim 8, wherein said electricity control circuit works to determine a target value of the feeding signal as a function of the sensor signal.

12. A gas concentration measuring apparatus as set forth in claim 8, further comprising a second pump cell working to produce a pump signal as a function of concentration of the given gas component within a second gas chamber formed within said gas base downstream of the gas chamber, and wherein said electricity control circuit works to determine a target value of the feeding signal as a function of the pump signal.

13. A gas concentration measuring apparatus as set forth in claim 8, wherein said electricity control circuit is designed to produce a voltage modulated by a PWM signal and convert the modulated voltage into a DC voltage to be applied to the first and second electrodes of the pump cell.

14. A gas concentration measuring apparatus as set forth in claim 13, wherein said electricity control circuit works to produce the DC voltage within a range between binary voltage levels.

15. A gas concentration measuring apparatus as set forth in claim 14, wherein said electricity control circuit includes a modulating circuit working to switch the voltage between the binary voltage levels using the PWM signal.

16. A gas concentration measuring apparatus comprising:
a gas sensor including a sensor base and a pump cell, the sensor base including a solid electrolyte body which defines within the sensor base a gas chamber into which gases are admitted through a given diffusion resistance, the pump cell being made up of a first and a second electrode affixed to the solid electrolyte body with the first electrode exposed to the gas chamber and responsive to application of electricity to the first and second electrodes to pump a given gas component out of and into the gas chamber selectively to produce a sensor signal in the form of an electrical change as a function of a pumped amount of the given gas component;
an electricity control circuit working to produce a feeding signal having one of discrete electrical values to control the electricity applied to the first and second electrodes of the pump cell;
a sensor signal detecting-circuit working to detect the sensor signal outputted form the pump cell and produce a sensor output as a function of concentration of the given gas component; and
a blurring circuit working to blur the feeding signal produced by said electricity control circuit.

17. A gas concentration measuring apparatus as set forth in claim 16, wherein said blurring circuit is implemented by an integrating circuit which works to integrate the feeding signal.

18. A gas concentration measuring apparatus as set forth in claim 16, wherein said electricity control circuit works to determine a target value of the feeding signal as a function of the sensor signal.

19. A gas concentration measuring apparatus as set forth in claim 16, further comprising a second pump cell working to produce a pump signal as a function of concentration of the given gas component within a second gas chamber formed within said gas base downstream of the gas chamber, and wherein said electricity control circuit works to determine a target value of the feeding signal as a function of the pump signal.

20. A gas concentration measuring apparatus as set forth in claim 16, wherein said electricity control circuit is designed to produce a voltage modulated by a PWM signal and convert the modulated voltage into a DC voltage to be applied to the first and second electrodes of the pump cell.

21. A gas concentration measuring apparatus as set forth in claim 20, wherein said electricity control circuit works to produce the DC voltage within a range between binary voltage levels.

22. A gas concentration measuring apparatus as set forth in claim 21, wherein said electricity control circuit includes a modulating circuit working to switch the voltage between the binary voltage levels using the PWM signal.
